(19) United States
(12) Patent Application Publication
(10) Pub. No.: US 2007/0223399 A1
(43) Pub. Date: Sep. 27, 2007

(54) Method of Configuring Native VLAN and Processing Ethernet Messages for a GPON System

(75) Inventors: Sulin Yang, Shenzhen (CN); Gang Zheng, Shenzhen (CN)

Correspondence Address: CONLEY ROSE, P.C., 5700 GRANITE PARKWAY, SUITE 330, PLANO, TX, 75024, US

(73) Assignee: Huawei Technologies Co., Ltd., Shenzhen (CN)

(21) Appl. No.: 11/610,159

(22) Filed: Dec. 13, 2006

(30) Foreign Application Priority Data
Mar. 22, 2006 (CN) 200610034630.6

(51) Int. Cl. H04L 12/28

(52) U.S. Cl. 370/254

(57) ABSTRACT

A method for ONT processing of Ethernet messages, comprising: A. the ONT receiving an Ethernet message from the UNI, and, if the Ethernet message doesn't contain a VLAN tag, adding the VLAN tag specified in the Native VLAN property of the UNI to the Ethernet message before forwarding it to the GPON protocol processing module, and; otherwise, forwarding the Ethernet message to the GPON protocol processing module; B. the ONT receiving the downstream Ethernet message with the VLAN tag from the GPON protocol processing module and, if the VLAN tag of the Ethernet message is the same as the one specified in the Native VLAN property of the UNI, removing the VLAN tag before forwarding it to the equipment connected to the UNI for the Ethernet message via the UNI; otherwise, directly forwarding the Ethernet message to the equipment connected to the UNI for the Ethernet message.

### CROSS-REFERENCE TO RELATED APPLICATIONS

This application is claiming priority of Chinese Application No. 200610034630.6 filed Mar. 22, 2006, entitled “Method for Configuring Native VLAN and Processing Ethernet Messages for a GPON System” which application is incorporated by reference herein in its entirety.

### BACKGROUND

The present disclosure relates to Passive Optical Network (PON) technologies, and more particularly to a method for an Optical Network Terminal (ONT) to handle Ethernet frames.

Broadband access technology consists of copper (e.g. Digital Subscriber Loop (DSL)) and fiber technology. The access network achieved through fiber technology is an optical access network (OAN).

Within the OAN, the Passive Optical Network (PON) is a point to multipoint technology, as depicted in FIG. 1.

Optical Line Terminal (OLT): An OLT provides the network-side interface for the OAN and is connected to one or more ODNs.

Optical Distribution Network (ODN): An ODN carries the optical transmission from the OLT to the users and vice versa. It utilizes passive optical components.

Optical Network Unit (ONU): An ONU provides, directly or remotely, the user-side interface of the OAN and is connected to the ODN.

Optical Network Terminal (ONT): An ONT is an ONU used for fiber to the home (FTTH) that includes a User Port function, such as an Ethernet or a Plain Old Telephone Service (POTS) interface. Without pointing out specifics, the ONT is used as the description of the ONT and the ONU in the rest of this disclosure.

A Gigabit Passive Optical Network (GPON), which is defined in the ITU-T standards G.984.1, G.984.2, G.984.3, and G.984.4, has more valuable features, such as the capability for carrying time division multiplexed (TDM) services in the native mode and high efficiency encapsulation. In the GPON standard, an interface called an ONU Management and OLT during ONT activation. Through the OMCI, the OLT can manage and configure the ONT. The OMCI is a master-slave management protocol: the OLT is the master and ONT is the slave. The OLT can manage and configure additional connected ONTs through the OMCI channel.

The OMCI protocol runs between the OLT controller and the ONT controller that is established at ONT initialization. The OMCI protocol is asymmetric: the controller in the OLT is the master and the controller in the ONT is the slave. A single OLT controller using multiple instances of the protocol over separate control channels may control multiple ONTs.

A protocol-independent Management Information Base (MIB) is used to describe the exchange of information across the OMCI and forms the basis from which protocol-specific models (e.g. Simple Device Protocol for the ONT) are defined. The protocol-independent MIB presented in ITU-T Rec. G.984.4 has been defined in terms of managed entities. The managed entities are abstract representations of resources and services in an ONT.

Within a Local Area Network (LAN), a Virtual Local Area Network (VLAN), which is defined in IEEE 802.1Q, can be used to separate user traffic from prohibited broadcast domains. An IEEE 802.1Q bridge can attach a VLAN Tag to a received Ethernet frame. A VLAN Tagged Ethernet frame is depicted in FIG. 2. The value of the Tag Protocol Identity (TPID) is 0x8100, and the value of (Tag Control Information (TCI) is determined by the policy for an Ethernet port to attach the VLAN ID.

In a GPON system, in order to separate traffic by different users or by different services, different VLAN Tags are allocated to the different users or the different services. For example, the ONT can attach VLAN tags to the user's data frames based on the Ethernet port. The procedure of the ONT attaching the VLAN tag is depicted in FIG. 3. First, the ONT receives untagged frames from the user network interface (UNI). Then, the ONT media access control (MAC) bridge module attaches a VLAN tag to the received untagged frames and sends them to the Gigabit PON (GPON) Transmission Convergence (GTC) module through an internal interface. Finally, the ONT's GTC module encapsulates the frames tagged by the MAC bridge module into a GPON frame and sends them to the OLT.

Some customer devices, such as those that connect to the ONT UNI, support VLAN tagging (e.g. Integrity Access Device (IAD), while some other customer devices do not support VLAN tagging (e.g. personal computers (PCs)), and an ONT's UNI may be connected to a plurality of customer premise equipment (CPE). When a UNI connects to multiple customer devices, each of them attaches different VLAN tags, some of which do not support VLAN tagging, then a native VLAN parameter should be configured to this UNI. A UNI with Native VLAN attributes will set a default VLAN tag. The UNI with native VLAN attributes will attach the default VLAN tag to the untagged frame from the CPE. If the VLAN tagged frames are received, the UNI with the Native VLAN attributes will transmit the frame from the CPE without any treatment. In the downstream direction, the UNI with the native VLAN attributes will remove the VLAN tag, which is identical to the default VLAN tag, from the downstream frames and will transparently transmit the downstream frame with the other VLAN tags to the CPE.

Through the Native VLAN attributes, the VLAN Tag mismatch can be resolved in multiple interconnected devices. Furthermore, when one UNI connects multiple devices, whether or not the VLAN Tagging operation is supported, the UNI can also keep user or traffic isolation.

In GPON standards, the definition of a VLAN Tagging Configuration Data managed entity (ME) is as follows.

VLAN Tagging Operation Configuration Data

This managed entity is used to organize the data associated with VLAN tagging. Instances of this managed entity are created and/or deleted at the request of the OLT.

Relationship

Zero or one instance of this managed entity may exist for each instance of the Physical Path Termination Point Ethernet UNI.

Attributes

Managed Entity ID: This attribute provides a unique number for each instance of this managed entity. The assigned number is the same as the ID of the Physical Path Termination Point Ethernet UNI with which this VLAN Tagging Operation Configuration Data instance is associated. (R, Set-by-create) (mandatory) (2 bytes)

Upstream VLAN Tagging Operation Mode: This attribute selects whether or not upstream VLAN tagging is sent.

Valid values are 0x00 (upstream frame is sent “as is,” regardless of whether or not the received frame is tagged); 0x01 (The upstream frame is sent as tagged whether or not the received frame is tagged. The TCI, consisting of the VLAN identifier (VID), the Canonical Format Indicator (CFI), and the user priority, is attached or overwritten by using the Upstream VLAN Tag TCI Value); and

0x02 (The upstream frame is sent as tagged whether or not the received frame is tagged. If the received frame is tagged, a second tag (Q-n-Q) is added to the frame. If the received frame is not tagged, a tag is attached to the frame. The TCI, consisting of the VID, the CFI, and the user priority, is attached or added by using the Upstream VLAN Tag TCI Value). (R, W, Set-by-create) (mandatory) (1 byte)

Upstream VLAN Tag TCI Value: This attribute indicates the TCI value for upstream VLAN tagging. It is used when the Upstream VLAN Tagging Operation Mode is 0x01. Any 2-byte value is acceptable. (R, W, Set-by-create) (mandatory) (2 bytes)

Downstream VLAN Tagging Operation Mode: This attribute selects whether or not downstream VLAN tagging is sent. Valid values are 0x00 (downstream frame is sent “as is,” regardless of whether or not the received frame is tagged) and 0x01 (The downstream frame is sent as untagged whether or not the received frame is tagged). (R, W, Set-by-create) (mandatory) (1 byte)

According to the definition, when the attribute ‘Upstream VLAN Tagging Operation Mode’ is 0x01, the untagged frame is attached to a VLAN tag configured in the attribute ‘Upstream VLAN Tag TCI Value’ and the VLAN Tag in the single tagged frame is replaced by the ‘Upstream VLAN Tag TCI Value’. That is to say, all of the upstream frames have the same VLAN Tag.

VLAN Tagging Operation Configuration Data ME does not define the operation mode of the Native VLAN. The upstream operation mode (0x01) cannot discriminate multiple users or services when multiple types of Ethernet frames (untagged, single tagged) arrive at the UNI. The upstream operation mode (0x00) is a transparent mode, which cannot attach the VLAN tag to the untagged upstream frames. Therefore, in current standards, the ONT cannot provide the capability for one UNI connecting multiple customers or multiple types of CPE (each type of CPE provides one service, that is to say adds a different VLAN Tag) of one user. Also, each ONT UNI cannot provide the ability to connect supporting VLAN Tagging devices, and does not support VLAN Tagging devices, and provides users or services separation simultaneously.

### SUMMARY

An embodiment of the present disclosure provides a method for the ONT to handle Ethernet frames, to solve the problem that an ONT UNI needs to separate users or services and connect multiple users or multiple CPE of one user.

The embodiment of the present disclosure provides a method for Native VLAN configuration in GPON, comprising:

A. The configuration terminal sends the configuration command to the ONT to configure the Native VLAN for an ONT UNI; and

B. The ONT stores the Native VLAN attributes as a VLAN Tagging Operation Configuration Data ME and responds to the configuration terminal.

An embodiment of the present disclosure also provides a method for the ONT to handle Ethernet frames, the method comprises:

A: The ONT MAC bridge module receives Ethernet frames from the Ethernet UNI in the upstream direction. If the Ethernet frame is untagged, the ONT will add a VLAN tag that is configured in the Native VLAN Tag attribute for the UNI, and sends the dealt frame to the GTC module. Otherwise, the MAC bridge module forwards the frame to the GTC module directly.

B: The ONT MAC bridge module receives VLAN tagged Ethernet frames from the GTC module in the downstream direction. If the frame has the same VLAN tag as the Native VLAN tag for a special UNI, the MAC bridge module will remove the VLAN tag before forwarding the frame to the CPE by the UNI. Otherwise, the MAC bridge module will directly forward the frame to the connected CPE by the UNI.

In the embodiment of the present disclosure, by defining Native VLAN operation mode in the VLAN tagging operation configuration Data ME, the problem that an ONT UNI cannot connect multiple CPEs with different VLAN characteristics is solved. That is, a UNI can connect multiple CPEs with different VLAN characteristics and the multiple CPEs can be identified by the Native VLAN tag. Therefore, the embodiment of the present disclosure can reduce the capital expenditures (CAPEX) for the layout of GPON system.

### BRIEF DESCRIPTION OF THE DRAWINGS

FIG. 1 is a diagram illustrating one embodiment of the structure of the PON.

FIG. 2 is a diagram illustrating one embodiment of the structure of the VLAN tagged Ethernet frame.

FIG. 3 is a diagram illustrating one embodiment of the transforming of VLAN tagged Ethernet frames.

FIG. 4 is a flowchart of one embodiment of a Configuration Terminal configuring the Native VLAN attributes of an ONT UNI through the OLT.

FIG. 5 shows one embodiment of the ONT handling the Ethernet frames from the UNI side with the Native VLAN tagging operation.

FIG. 6 is a flowchart of one embodiment of the MAC bridge module within the ONT handling the upstream frames from the UNI which is configured with Native VLAN attributes.

FIG. 7 shows one embodiment of the ONT handling the downstream frames with Native VLAN tagging operation.

FIG. 8 is a flowchart of one embodiment of the MAC bridge module within ONT handling the downstream frames to customer devices through a Native VLAN configured UNI.

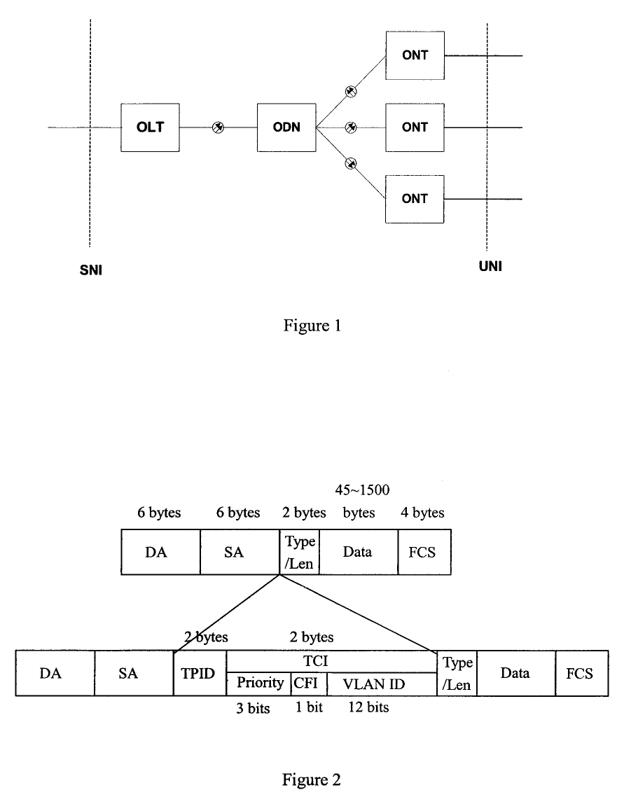

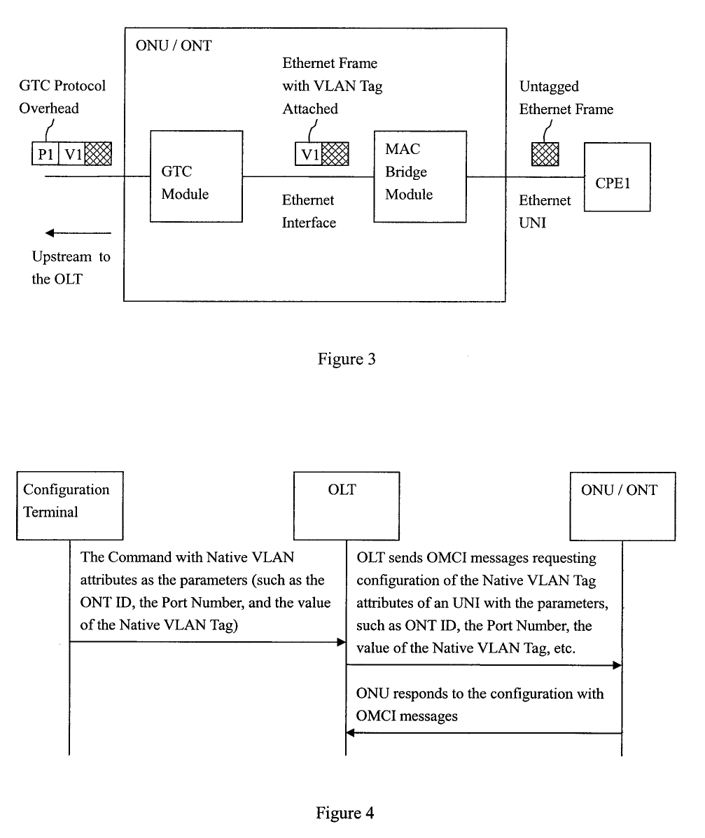

### DETAILED DESCRIPTION

Embodiments of the present disclosure will be described hereinafter with reference to the accompanying drawings.

One of the fundamental parts of the embodiment of the present disclosure is to add newly configurable Native VLAN attribute to the VLAN Tagging Operation Configuration Data ME. When an UNI with Native VLAN attributes receives Ethernet frames from the connected devices, the MAC bridge module will add a VLAN tag in the Native VLAN attribute to untagged frames and transform only the VLAN tagged frames. When an UNI with the Native VLAN attributes receives downstream Ethernet frames, the MAC bridge module removes the VLAN tag for the frames with the VLAN tag equivalent with the value in the Native VLAN tag attribute before sending it to connected devices, and directly transforms the frames with the VLAN tag different with the value in the Native VLAN tag attribute.

The following is the detailed description of the VLAN Tagging Operation Configuration Data ME.

The VLAN tagging operation configuration Data ME in the embodiment of the present disclosure that support Native VLAN attribute is:

Managed Entity: VLAN Tagging Operation Configuration Data

Relationship: Zero or one instance of this managed entity may exist for each instance of Physical Path Termination Point Ethernet UNI.

Attributes:

Managed Entity ID: This attribute provides a unique number for each instance of this managed entity. The assigned number is the same as the ID of the Physical Path Termination Point Ethernet UNI with which this VLAN Tagging Operation Configuration Data instance is associated. (R, Set-by-create) (mandatory) (2 bytes)

Upstream VLAN Tagging Operation Mode: This attribute selects whether or not the upstream VLAN tagging is sent.

Valid values are 0x00 (upstream frame is sent “as is,” regardless of whether or not the received frame is tagged);

0x01 (The upstream frame is sent as tagged whether or not the received frame is tagged. The TCI, consisting of the VID, the CFI, and the user priority, is attached or overwritten by using the Upstream VLAN Tag TCI Value); and

0x02 (The upstream frame is sent as tagged whether or not the received frame is tagged. If the received frame is tagged, a second tag (Q-n-Q) is added to the frame. If the received frame is not tagged, a tag is attached to the frame. The TCI, consisting of the VID, the CFI, and the user priority, is attached or added by using the Upstream VLAN Tag TCI Value); and

0x03 (The untagged upstream frame is sent as tagged, TCI, is attached by using the Upstream VLAN Tag TCI Value, while VLAN tagged upstream is sent transparently). (R, W, Set-by-create) (mandatory) (1 byte)

Upstream VLAN Tag TCI Value: This attribute indicates the TCI value for upstream VLAN tagging. It is used when the Upstream VLAN Tagging Operation Mode is 0x01. Any 2-byte value is acceptable. (R, W, Set-by-create) (mandatory) (2 bytes)

Downstream VLAN Tagging Operation Mode: This attribute selects whether or not downstream VLAN tagging is sent. Valid values are 0x00 (downstream frame is sent “as is,” regardless of whether or not the received frame is tagged), 0x01 (The downstream frame is sent as untagged whether or not the received frame is tagged), and 0x02 (If the downstream frame has the VLAN tag equivalent with Upstream VLAN Tag TCI Value, it is sent as untagged, otherwise it is sent transparently). (R, W, Set-by-create) (mandatory) (1 byte)

Wherein, add “mode 0x03 (The untagged upstream frame is sent as tagged, TCI, is attached by using the Upstream VLAN Tag TCI Value, while VLAN tagged upstream is sent transparently.)” to Upstream VLAN Tagging Operation Mode attribute and “mode 0x02 (If the downstream frame has the VLAN tag equivalent with Upstream VLAN Tag TCI Value, it is sent as untagged, otherwise it is sent transparently)” to the Downstream VLAN Tagging Operation Mode.

The flowchart that a configuration terminal uses to configure an UNI with Native VLAN attributes through the ONT is depicted in FIG. 4.

Step 1: The configuration terminal sends a Native VLAN configuration command that includes such parameters as ONT identity, port number of the UNI which need to configure the Native VLAN attributes, and the value of Native VLAN Tag.

Step 2: The OLT sends OMCI messages to the ONT requesting the ONT to configure the Native VLAN attributes of an ONT. The OMCI messages include the parameters, such as ONT identity, port number of the UNI which needs to configure the Native VLAN attributes, and the value of Native VLAN Tag.

Step 3: The ONT stores the Native VLAN attributes in the VLAN Tagging Operation Configuration Data ME for the corresponding UNI and responds with an OMCI message.

Besides the above approach, the configuration terminal can also directly (e.g. through a universal asynchronous receiver/transmitter (UART)) or remotely (e.g. through Telnet) send the command to the ONT to configure the Native VLAN attribute. The ONT stores the parameters in the command in the VLAN Tagging Operation Configuration Data ME of the corresponding.

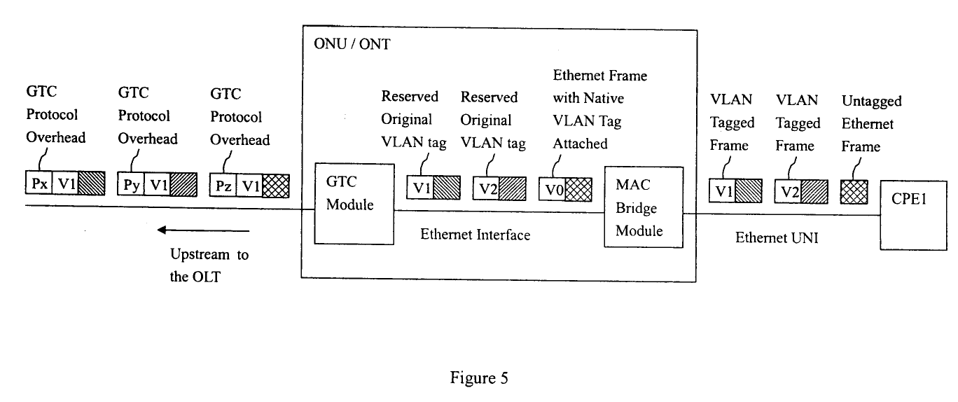

After the configuration above, the ONT can handle the received frames according to the Native VLAN attributes of the corresponding UNI, which is depicted in FIG. 5.

When the frames are received, the MAC Bridge module within the ONT checks the frame structure, directly sends the frames that already have VLAN tags (e.g. the frames with VLAN Tag V1 and V2), and attaches a VLAN tag with the value configured in the Upstream VLAN Tag TCI Value attribute (e.g. V0) to the untagged frames. After that, the frames with different VLAN tags will be sent to the GTC module through internal Ethernet interface. Finally, GTC module will do some operation, such as attaching the necessary protocol overhead to form the GPON frames and sent the GPON frames to the OLT.

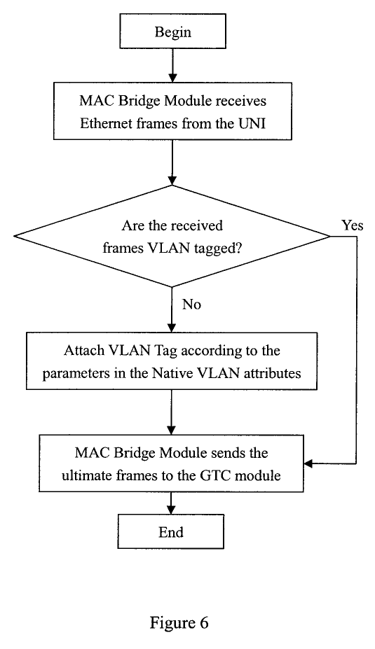

FIG. 6 provides the flowchart for how the MAC bridge module within the ONT deals with the received frame from the UNI with Native VLAN attributes:

Step 1: The MAC bridge module receives the upstream frames from the UNI with Native VLAN attributes configured UNI;

Step 2: The MAC bridge module checks whether the frames are VLAN tagged or not, if the frames are VLAN tagged, the flow goes to step 4; otherwise the flow goes to step 3;

Step 3: The MAC bridge module attaches a VLAN tag designated in the Native VLAN attributes of the UNI to the untagged frames;

Step 4: The MAC bridge module transforms the frames (Native VLAN Tagged or not) to the GTC module through the internal interface;

Step 5: The GTC module does some necessary operation, such as attaching a GTC protocol overhead to form GTC frames, and sends the GTC frames to the OLT.

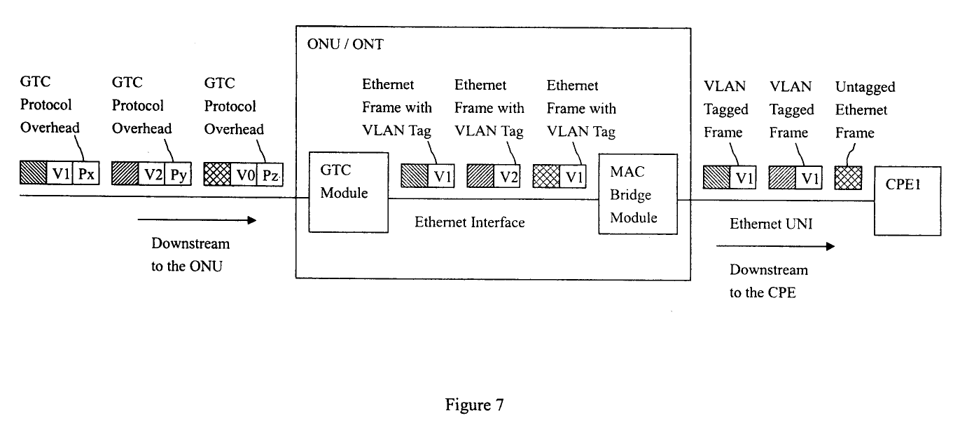

FIG. 7 shows how the ONT handles the downstream frames to an UNI with Native VLAN configured from the GTC module:

The GTC module receives the GTC frames from the OLT, removes the necessary GTC protocol overheads, and sends the produced Ethernet frames with the VLAN tags to the MAC bridge module through internal interface. After receiving the downstream VLAN tagged frames, the MAC bridge module first compares the VLAN tag in the frames with the Upstream VLAN Tag TCI Value in the VLAN Tagging Operation Configuration Data ME of the UNI to the destination of the received downstream frames. If they are different from each other, the MAC bridge module directly sends the received downstream VLAN tagged frames to the connected customer devices (e.g. the frames with VLAN tag V1 and V2) through the UNI. If they are same, the MAC bridge module removes the VLAN tag from the received downstream VLAN tagged frames (e.g. the frames with VLAN tag V0), and sends the ultimate untagged frames to the connected customer devices through the UNI.

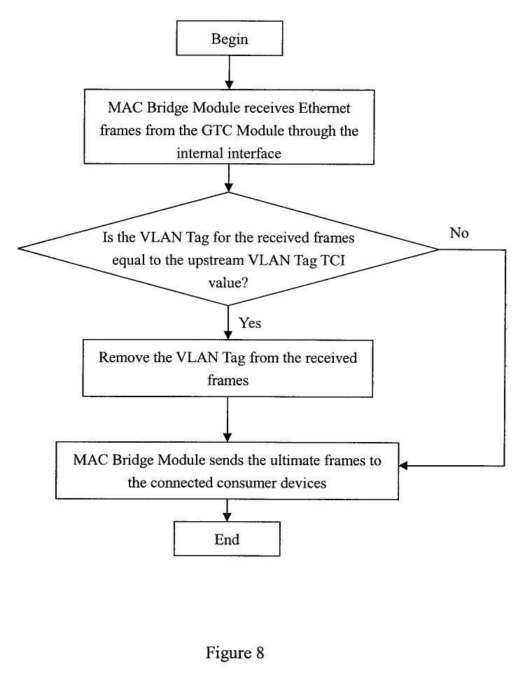

The procedure that the MAC bridge module within the ONT uses to handle the received downstream frames to a Native VLAN attribute configured UNI from the GTC module through the internal interface is represented in FIG. 8:

Step 1: the MAC bridge module within the ONT received downstream frames to a Native VLAN attribute configured UNI from the GTC module through the internal interface;

Step 2: The MAC bridge module within the ONT compares the VLAN tag of the received downstream frames with the attribute Upstream VLAN Tag TCI Value in the VLAN Tagging Operation Configuration Data ME of the UNI to the destination of the received downstream frames. If they are same, the flow goes to step 3; otherwise, the flow goes to step 4;

Step 3: The MAC bridge module removes the VLAN tag of the received downstream frames which is equal to the attribute Upstream VLAN Tag TCI Value in the VLAN Tagging Operation Configuration Data ME; and

Step 4: The MAC bridge module sends the ultimate frames to the connected customer devices through the corresponding UNI.

The foregoing descriptions are only preferred embodiments of the present disclosure and not used for limiting the protection scope thereof. Any changes and modifications may be made in light of the foregoing description by those skilled in the art without departing from the principle and spirit of this disclosure, and therefore should be covered within the protection scope of this disclosure as set by the appended claims.

1-12. (canceled)

13. A passive optical network (PON) component comprising:
a processor configured to implement a method comprising:
promoting transmission of a message requesting configuration of a virtual local area network (VLAN) attribute to an optical network terminal (ONT),
wherein, upon receiving the message, the ONT stores the native VLAN attribute in a VLAN tagging operation configuration data managed entity.

14. The PON component of claim 13, wherein the message comprises an ONT identity, a port number for a user network interface (UNI) associated with the native VLAN attribute, and a native VLAN tag.

15. The PON component of claim 13, wherein a preconfigured VLAN tag is associated with a port configured with the native VLAN attribute.

16. The PON component of claim 15:
wherein when an upstream message is received on the port and does not contain the VLAN tag, the preconfigured VLAN tag is added to the upstream message before the upstream message is sent upstream,
wherein when an upstream message is received on the port and contains the VLAN tag, the upstream message is sent upstream with the original VLAN tag unchanged,
wherein when a downstream Ethernet message is received and contains the preconfigured VLAN tag, the preconfigured VLAN tag is removed before the downstream message is sent downstream, and
wherein when a downstream message is received and does not contain the preconfigured VLAN tag, the message is sent downstream without changing the preconfigured VLAN tag.

17. The PON component of claim 13:
wherein the method further comprises recognizing the reception of a native VLAN configuration command from a configuration terminal,
wherein the native VLAN configuration command comprises an ONT identity, a port number for the user network interface (UN) that needs to configure the native VLAN attribute, and a native VLAN tag,
wherein the message is transmitted using an ONT management and control interface (OMCI) channel, and
wherein the message comprises the ONT identity, the port number for the UNI that configures the native VLAN attribute, and the native VLAN tag.

18. The PON component of claim 13, wherein the native VLAN configuration command is sent directly or via a remote control, and wherein the native VLAN configuration command comprises an ONT identity, a port number for the user network interface (UNI) that configures the native VLAN attribute, and a native VLAN tag.

19. The PON component of claim 13, wherein the PON is a Gigabit PON.

20. The PON component of claim 13, wherein the method further comprises recognizing the reception of a configuration response message from the ONT.

21. A method comprising:
receiving a message from a user network interface (IJNI);
determining whether the message contains a virtual local area network (VLAN) tag;
adding the VLAN tag specified by a native VLAN attribute to the message if the message does not contain the VLAN tag; and
forwarding the message to a passive optical network (PON) processing module.

22. The method of claim 21, wherein the message is an Ethernet message and the PON is a Gigabit PON.

23. The method of claim 21, wherein the message is forwarded to the PON processing module without adding the VLAN tag if the message already contains the VLAN tag.

24. The method of claim 21, wherein a configuration terminal configures the native VLAN.

25. The method of claim 21 wherein the PON processing module adds a header to the message, generates an encapsulated frame using the header and the message, and sends the encapsulated frame to an optical line terminal.

26. The method of claim 21 further comprising:
receiving a second message comprising a second VLAN tag from the PON processing module;
determining whether the second VLAN tag is specified in the native VLAN attribute;
removing the second VLAN tag from the second message if the second VLAN tag is specified in the native VLAN attribute; and
forwarding the second message to equipment connected to the UNI.

27. The method of claim 26, wherein the message is forwarded to the equipment without removing the VLAN tag if the second VLAN tag is not specified in the native VLAN attribute.

28. The method of claim 26 wherein the PON processing module receives an encapsulated frame from an optical line terminal, and removes a header from the encapsulated frame, thereby producing the second message.

29. An optical network terminal (ONT) comprising:
a media access control (MAC) bridge module configured to receive a plurality of frames, determine whether the frames contain virtual local area network (VLAN) tags, and add VLAN tags to any frames that do not contain VLAN tags.

30. The ONT of claim 29 further comprising:
a transmission convergence module configured to receive the frames from the MAC bridge module, add a protocol overhead to the frames, and send the frames to an optical line terminal.

31. The ONT of claim 29, wherein the MAC bridge module does not add VLAN tags to any frames that already contain VLAN tags.

32. The ONT of claim 29 wherein the VLAN tags added to the frames are specified in a native VLAN attribute.
